(19) United States
(12) Patent Application Publication
(10) Pub. No.: US 2008/0220754 A1
(43) Pub. Date: Sep. 11, 2008

(54) IP BASED LAWFUL INTERCEPTION AT THE SOURCE

(75) Inventors: Neset Arda Erol, Vancouver (CA); Ronald McLeod, Richmond (CA)

Correspondence Address: UTSTARCOM, INC.;c/o Laura Weiss, Paralegal, 3800 Golf Road, Suite 220, Rolling Meadows, IL, 60008, US

(73) Assignee: UTSTARCOM, INC., Alameda, CA (US)

(21) Appl. No.: 11/683,619

(22) Filed: Mar. 8, 2007

(51) Int. Cl. H04M 3/58

(52) U.S. Cl. 455/417

(57) ABSTRACT

A system and method for lawful intercept of call content incorporates a control element receiving subscriber information as a lawful intercept target and issuing a media forking command to a media transfer element transmitting RTP data. The media transfer element receives the media forking command and provides duplicates of RTP data packets associated with the subscriber transmitted through the media transfer element for transmission to a delivery function. The media forking command is an attribute in an SDP and includes definition of IP addresses for at least one delivery function. An acknowledgement of the forking command from the media transfer element to the control element is provided.

### FIELD OF THE INVENTION

This invention relates generally to the field of interception of electronic transmission by law enforcement agencies and, more particularly, to a system and method for lawful interception of the contents of mobile telephone calls through the use of media forking directly from base station controllers handling the call.

### DESCRIPTION OF THE RELATED ART

Law enforcement agencies (LEA) may obtain court orders for monitoring or intercepting electronic communications of certain individuals or organizations. This procedure, classically called “wire tapping” has regularly been employed with public switched telephone networks through physical switching arrangements. The development and use of wireless communications devices, primarily mobile or cellular phones has created additional technical complexity in carrying out such lawful interception of communications.

Standards for systems configured to allow lawfully authorized interception have been developed by the Telecommunications Industry Association (see ANSI J-STD25A “Lawfully Authorized Electronic Surveillance”). Systems meeting this standard and both industry and low enforcement agency needs and requirements must be capable of identifying communications of an intercept subject or target and provide information to be intercepted for both call content and call identifying information. Further, to be effective, such systems must operate covertly to preclude knowledge by the intercept subject of the interception. Systems implemented by telecommunication providers nominally must provide an access function for the call content and call identifying information and a delivery function for that information to a LEA system for collection and processing. Most current intercept approaches involve the addition of an additional server or other data processing system through which all call data passes to allow selection and relay of the desired information for a target. This approach requires significant additional system complexity and often inserts delays in the system that affect call quality of service.

It is therefore desirable to provide a system and method which seamlessly provides call identifying information and content without adding unnecessary complexity or financial cost to the system as a whole and which operates in a manner that is undetectable by the intercept subject or the parties communicating with the subject.

In an all-IP telephony network, Lawful Interception (LI) of call-content cannot be carried out directly using traditional (e.g. TDM-based or ATM-based) technologies. Instead of adding TDM and/or ATM-based LI equipment to the network, therefore, it is desirable to perform LI at the Real Time Transport Protocol (RTP) level.

### SUMMARY OF THE INVENTION

The present invention provides a system and method for lawful intercept of call content wherein a control element receives subscriber information as a lawful intercept target and issues a media forking command to a media transfer element transmitting RTP data. The media transfer element receives the media forking command and provides duplicates of RTP data packets associated with the subscriber transmitted through the media transfer element for transmission to a delivery function. In exemplary embodiments, the media forking command includes definition of IP addresses for at least one delivery function and the media forking command comprises an attribute in an SDP. For certain embodiments, an acknowledgement of the forking command from the media transfer element to the control element is provided.

### BRIEF DESCRIPTION OF THE DRAWINGS

These and other features and advantages of the present invention will be better understood by reference to the following detailed description when considered in connection with the accompanying drawings wherein:

FIG. 1 is a block diagram of an exemplary communications system employing RTP media transfer for incorporation of the present invention;

FIG. 2 is a flow diagram of the interaction of elements in the system of FIG. 1 for media forking according to the present invention; and,

FIG. 3 is a block diagram of the VSOE element in an exemplary embodiment of the invention.

### DETAILED DESCRIPTION OF THE INVENTION

Unlike prior art systems in which a dedicated device would need to carry a heavy load of traffic, as all media would be routed through it, the present invention completely avoids a costly new network element and utilizes existing media equipment. For the embodiment disclosed herein, Lawful Interception (LI) of mobile call contents is implemented directly on the Base Station Controllers (BSC) in the system via media forking. Using the method of the invention the BSC creates duplicate copies of any RTP packets incoming into and outgoing from any endpoint that is the target of Lawful Interception. The duplicate copies of these packets are then sent to one or more Lawful interception Delivery Functions (DF). The content and destination of the original copies of the packets is not altered in any way, so LI has no impact on the actual media streams.

When Lawful Interception is enabled on a call, in general application of the present invention, any equipment that generates and/or consumes RTP media streams for an LI Target becomes responsible to perform Lawful Interception of call content for that subscriber. Other equipment that can support similar media forking functionality include Media Gateways, IWFs, Media Resource Functions (announcements, conferencing, etc.), and Media Transcoders generally referred to herein as Media Transfer Elements. In order to enable LI on a specific subscriber, any media transfer element that generates and/or consumes RTP traffic for the subscriber is instructed to perform RTP packet forking. This can be done either at stream establishment time or at a later time depending on when LI-Information becomes available.

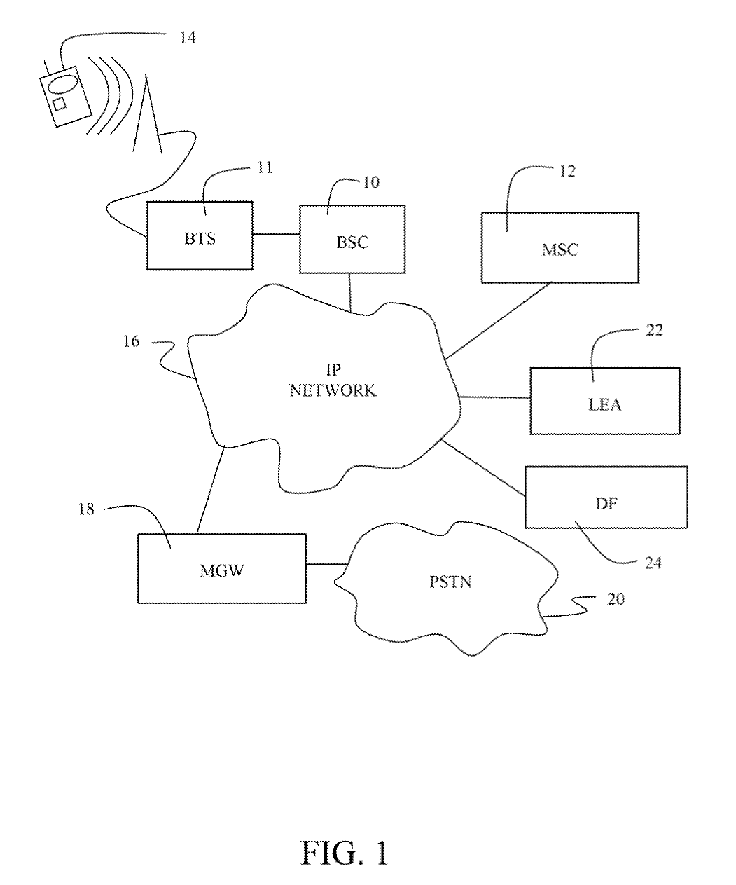

For the exemplary embodiment shown if FIG. 1 a BSC 10 is employed as a media transfer element for media forking. Mobile Switching Center (MSC) 12 provides the subscriber information for call data for mobile users 14 handled by the BSC. IP packet data for call content is routed through an IP network 16 to and from media gateways 18 which are also exemplary media transfer elements acting as either sources or destinations. The Public switched telephone network (PSTN) 20 is accessed as a source or destination through the media gateway which transcodes data to and from the IP Network and PSTN. The PSTN constitutes an indirect source/destination accessible in a system incorporating the present invention. Communications regarding lawful intercept are provided by Law Enforcement Agency controllers 22 and duplicated call data is routed through the network to one or multiple Delivery Functions 24.

The interface between the MSC and the BSC is modified in the present invention for an exemplary embodiment by adding an attribute in the session description protocol (SDP) in the format of:

a=X−NameMFreq:<incoming_destination_list>;<outgoing_destination_list>

The attribute name, X-NameMF (media forking) in the example, is followed by exactly one colon character. In alternative embodiments, the attribute name can be replaced with any value compatible with the SDP specification. The exemplary attribute name starts with “X−” consistent with the SDP specification (RFC 2327 recommendation that new experimental and/or unregistered (with IANA) attribute names should start with this prefix. Each destination list is defined as up to three ip:port pairs separated by commas, i.e.:

destination_list=ip:port,ip:port, . . . (0 to 4 ip:port pairs)

Normally only a single DF IP address and port pair would be required for a single LI target (two ports because of the interception of incoming and outgoing streams separately). However, scenarios of multiple LI targets in a common call or call sequence require additional forking capability. As an example for LI targets A, B and C, A sets his phone up to transfer all incoming calls to B's phone. B does the same and forwards all his calls to C. If the LEA sets up interception for A, B, and C, they will expect to see a separate stream pair for each LI target. So when A's call is ultimately forwarded to C through B, three fork pairs in total are required. If, for example, B is not a LI target, then the requirement is present to fork pairs (one pair for A and one pair for C). The LEA that are intercepting the calls of A, B, and C could even be different agencies, so the need for separate fork pairs cannot be avoided easily, without extra logic in the DF and/or LEAs themselves. In implementation of the embodiments presented herein the actual number has been increased from 3 to 4 to allow a call to be forwarded three times. Assuming all call participants in a call forward chain are LI targets, this requires a maximum of three fork pairs for the forward targets plus one for the original LI target; four fork pairs in total.

An example of the attribute with two ip:port pairs for each of the incoming and outgoing destination lists is shown in Example 1 below. For the exemplary embodiment, either/both destination lists may be empty and the colon after the attribute name and the semi-colon between the lists must always be present even when either list is empty as shown in Example 2.

### EXAMPLE 1

a=X−NameMFreq:192.168.0.10:5000,192.168.0.20:5002;192.168.0.10:5004,192.168.0.20:5006

### EXAMPLE 2

a=X−NameMFreq:;

In Example 1 each incoming RTP packet is duplicated twice; the duplicates are sent to destinations 192.168.0.10:5000 and 192.168.0.20:5002 and each outgoing RTP packet is duplicated twice; the duplicates are sent to destinations 192.168.0.10:5004 and 192.168.0.20:5006 (in addition to the original destination of the packet before the duplication).

When Lawful Interception of call contents is desired on an endpoint, the MSC needs to pass the above attribute to the BSC within a Remote SDP. The following exemplary SDP shows the use of the media fork attribute for one media fork for each media direction in addition to the original destination 172.16.129.23.
v=0
c=IN IP4 172.16.129.23
m=audio 16398 RTP/AVP 60
a=X−NameMFreq:192.168.0.10:5000;192.168.0.10:5004

In certain embodiments, if media fork parameters are accepted, the BSC embeds an “X-NameMFack” attribute inside the Local SDP that it returns in response to the original request. The format of the “X-NameMFack” attribute is identical to that of “X-NameMFreq” except for the attribute name signifying “Acknowledgement” instead of “Request”.

The command formate can easily be optimized if needed (e.g. a single IP address with 2 different port numbers can be specified for an incoming/outgoing stream fork pair). The design in the embodiments presented here is the most generic case that is flexible and future-proof.

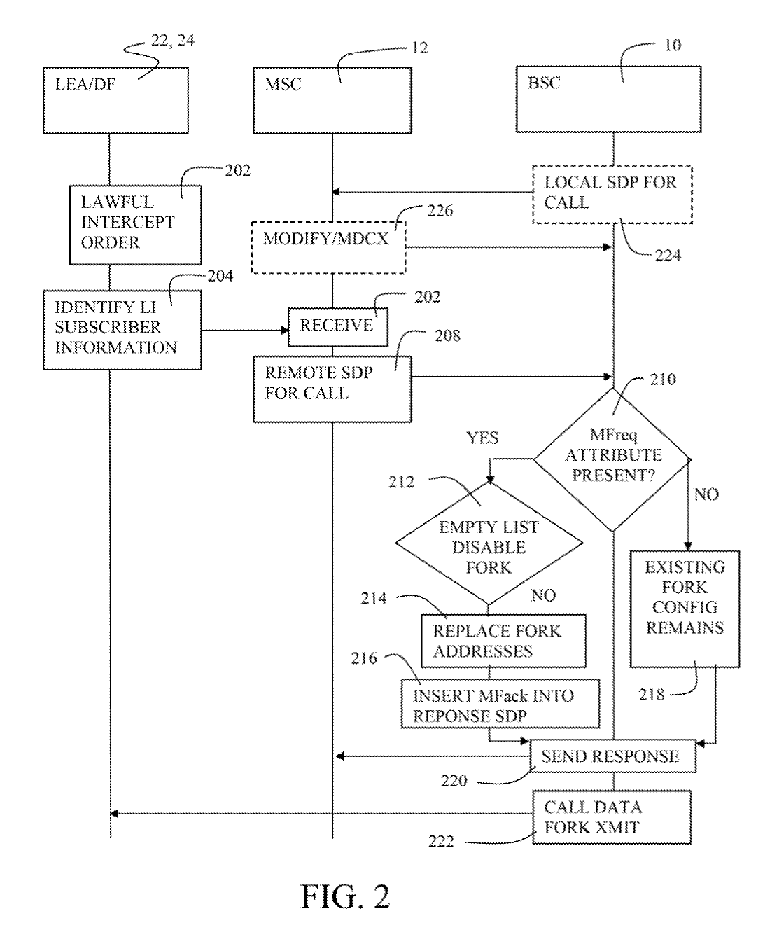

FIG. 2 shows the intercept sequence and the BSC behavior when the Remote SDP is received for the example SDP. A Lawful Intercept is authorized 202 and the LI information 204 is received 206 by the MSC 204. The MSC issues the remote SDP for the call 208. If the “X-NameMFreq” attribute is present 210, its parameters override any existing media fork configuration. As shown, if the attribute is present a determination is made whether to empty the list and disable the fork 212. If not, the fork addresses are replaced with the new set 214. The BSC inserts the “X-NameMFack” attribute in its response 216, acknowledging the new media fork setup. If the “X-NameMFreq” attribute is not present, then any previous media fork setup remains intact 218. The BSC sends its response to the MSC 220. Note that an empty destination list pair is used to disable media forking i.e. “a=X-NameMFreq:;”. The BSC does not generate the “X-NameMFack” attribute in its response. Call data responsive to a fork is transmitted 222 by the BSC to the DF for use by the LEA.

In certain instances, the remote SDP may not be present at the initiation of a call in which case the BSC will transmit a local SDP for the call 224 to the MSC which will respond with a modify/MDCX command 226 to the BSC to allow the remote SDP.

In a particular embodiment for a MEdia GAteway COntrol Protocol (H.248/RFC 3525) (MEGACO) based BSC, the BSC is instructed to enable RTP media forking by sending an additional attribute (having an attribute name of X-LI in the example below) in the Local and Remote session description protocols (SDPs) for incoming and outgoing media streams, respectively, as soon as LI-Information becomes available. A Local SDP and a Remote SDP are employed with the X-LI attribute inside the Local SDP containing the fork destination for the incoming stream. The X-LI attribute inside the Remote SDP contains the fork destination for the outgoing stream. The example SDP below uses this technique to set up two media forks (in addition to the original destination of the stream) to be sent to UDP ports 5000 and 5002 of a DF at IP address 192.168.0.10, for the incoming stream with UDP ports 6000 and 6002 for the outgoing stream.

### Local

v=0
c=IN IP4 172.16.129.23
m=audio 16398 RTP/AVP 60
a=X-LI:192.168.0.10:5000,192.168.0.10:5002

### Remote

v=0
c=IN IP4 172.16.129.23
m=audio 16398 RTP/AVP 60
a=X-LI: 192.168.0.1:6000,192.168.0.1:6002

In an alternative embodiment for Media Gateway Control Protocol (RFC 3435) (MGCP), because the Local SDP is never transmitted in the direction from the MGCP client to the MGCP server, both incoming and outgoing media stream forks are specified within the Remote SDP using a single attribute as described in paragraphs 13 to 19. The following example uses a single attribute; it differentiates between the incoming and outgoing streams via a semicolon separator:
v=0
c=IN IP4 172.16.129.23
m=audio 16398 RTP/AVP 60
a=X-LIL192.1689.0.1:5000,192.168.0.1:5002;192.168.0.1:6000,192.168.0.1:6002

The semicolon in the middle of the attribute string separates the incoming stream fork destinations at ports 5000 and 5002 from the outgoing stream fork destinations at ports 6000 and 6002. The example allows the use of different ports on a DF or multiple DFs at different IP addresses for the incoming and outgoing data.

To accommodate the interface requirements of the present invention, the Control Protocol module (i.e. MGCP, MEGACO, SIP, etc.) of the BSC is modified for the MediaDescriptor class to include the plurality of destination IP address and UDP port number pairs per forked media stream (i.e. the Delivery Function addresses). In certain embodiments SIP is a likely alternative to MEGACO for some Media Transfer Elements. For those devices, the style described for MEGACO can be applied directly because SIP allows the specification of both the local and the remote SDPs by the controller, an MSC in the examples described.

For MEGACO and SIP applications the destination addresses for the incoming RTP stream are stored inside the local media descriptor and the destination addresses for the outgoing RTP stream are stored inside the remote media descriptor. Alternatively, for MGCP both are stored in the remote SDP and the acknowledgement ack(MFack) for both are received in the Local SDP. The SDP parser includes software to accept the media fork attribute defined above and the SDP response generator incorporates software to generate the acknowledgement attribute defined above when media forking is enabled.

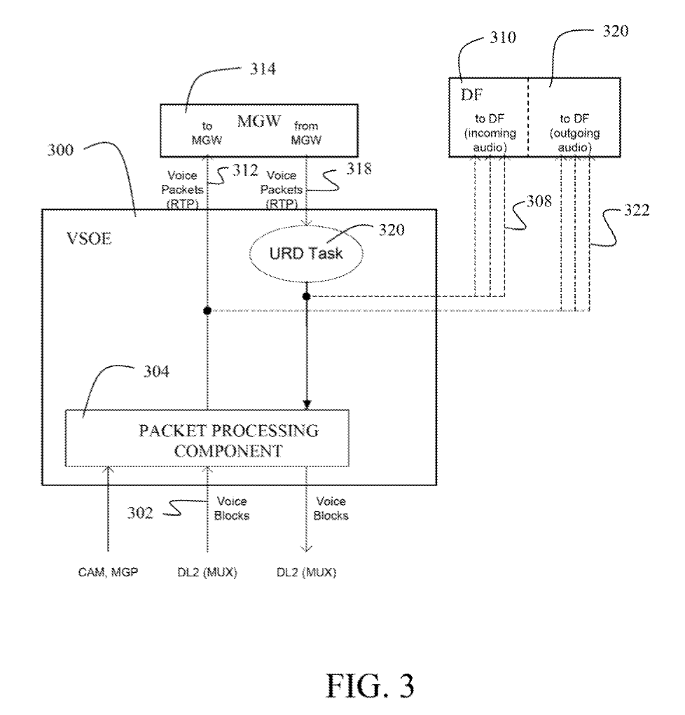

A Voice Service Option Element (VSOE) 300 of the BSC embodying the present invention is shown in FIG. 3. Forking of the outgoing media stream voice blocks 302 or other media through the Packet Processing Component 304 is performed to provide a duplicated RTP stream 308 for each of the Lawful Interception destinations 310 defined for the outgoing stream of RTP voice packets 312 sent to the media gateway 314. A media gateway is employed in the exemplary embodiment disclosed herein as representative of a Media Transfer Element in the generic case. Similarly, forking of the incoming media stream is performed on the RTP voice packets 318 received from the Media Gateway after identification of the subscriber data in the URD Task 320 to provide a duplicated RTP stream 322 for each of the Lawful Interception destinations 320 defined for the incoming stream.

Having now described the invention in detail as required by the patent statutes, those skilled in the art will recognize modifications and substitutions to the specific embodiments disclosed herein. Such modifications are within the scope and intent of the present invention as defined in the following claims.

What is claimed is:

1. A method for lawful intercept of call content comprising the steps of:
receiving subscriber information as a lawful intercept target;
issuing a media forking command to a media transfer element transmitting RTP data;
receiving the media forking command in the media transfer element and
providing duplicates of RTP data packets associated with the subscriber transmitted through the media transfer element for transmission to a delivery function.

2. A method as defined in claim 1 wherein the media forking command includes definition of IP addresses for at least one delivery function.

3. A method as defined in claim 1 further comprising the step of providing an acknowledgement of the forking command from the media transfer element.

4. A method as defined in claim 1 wherein the media forking command comprises an attribute in a SDP.

5. A method as defined in claim 3 wherein the acknowledgement comprises an attribute in a local SDP.

6. A method as defined in claim 2 wherein the forking command includes multiple delivery function IP addresses to support forwarded call interception.

7. A method as defined in claim 4 wherein the media the media forking command is an attribute having a format for
a=Name:<incoming_destination_>;<outgoing_destination_list>.

8. A method as defined in claim 7 wherein the incoming destination list and outgoing destination list are in the format destination_list=ip:port,ip:port, . . .

9. A method as defined in claim 1 wherein the media transfer element is a BSC and an MSC receives the lawful intercept target subscribe information and issues the media forking command.

10. A method as defined in claim 9 wherein the MSC and BSC employ MEGACO and the media forking command is an attribute in the Local and Remote session description protocols for incoming and outgoing media streams, respectively, sent by the MSC as soon as LI-Information becomes available and having a format of a=attributename:<destination_list>

11. A method as defined in claim 10 wherein the destination list in the format for incoming and outgoing media streams are in the format destination_list=ip:port,ip:port, . . .

12. A method as defined in claim 9 wherein the MSC and BSC employ MGCP and the media forking command is an attribute with both the incoming and outgoing media stream forks specified within the Remote SDP.

13. A method as defined in claim 12 wherein the attribute format is a=Attributename:incomingipaddress:port,incomingipaddress:port, . . . ;outgoingipaddre ss:port,outgoing address:port, . . .

14. A system for lawful intercept of call content comprising:
a control element for receiving subscriber information as a lawful intercept target, said control element having means for issuing a media forking command;
a media transfer element transmitting RTP data and having
means for receiving the media forking command and
means for providing duplicates of RTP data packets associated with the subscriber transmitted through the media transfer element for transmission to a delivery function.
